(19) United States
(12) Patent Application Publication
(10) Pub. No.: US 2005/0206054 A1
(43) Pub. Date: Sep. 22, 2005

(54) Vibration damping bushing

(75) Inventor: Naoki Nishi, Nagoya-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/071,313

(22) Filed: Mar. 4, 2005

(30) Foreign Application Priority Data
Mar. 18, 2004 (JP) 2004-078853

(51) Int. Cl. F16F 5/00

(52) U.S. Cl. 267/140.5; 267/293; 267/141.3

(57) ABSTRACT

A vibration damping bushing comprising: a main shaft member having at one end a sloping face that thrusts diametrically outward from the cylindrical portion while extending axially outwardly; an outer cylinder member disposed coaxially about the main shaft member with a radial distance therebetween; and a rubber elastic body connecting elastically the main shaft member and the outer cylinder member. The elastic body has a pair of outer hollow portions disposed to an outer circumferential portion, and a pair of inner hollow portions disposed to an inner circumferential portion thereof, so that there is disposed between the inner hollow portions and the outer hollow portions a pair of sloping arm portions formed so as to slope diametrically inward going from the inner circumferential surface of the outer cylinder member to the sloping face of the main shaft member.

### INCORPORATED BY REFERENCE

The disclosure of Japanese Patent Application No. 2004-078853 filed on Mar. 18, 2004 including the specification, drawings and abstract is incorporated herein by reference in its entirety.

### BACKGROUND OF THE INVENTION

1. Field of the Invention

The present invention relates to a vibration damping bushing favorable for use as a suspension bushing in a vehicle, for example.

2. Description of the Related Art

There have been employed in vehicle suspensions vibration damping bushings for linking an arm member or rod member to the vehicle body in a vibration-damped manner. For example, the arrangements taught in JP-A-10-246263, JP-A-2001-225622, JP-A-2001-248671 and JP-A-2002-295560 are known in the art. Such vibration damping bushings are typically composed of a main shaft member, an outer cylinder member disposed coaxial about the main shaft member and spaced apart to the outer peripheral side thereof, and a rubber elastic body that is interposed between the outer cylinder member and the main shaft member, integrally linking the two members.

This vibration damping bushing is mounted by securing with an attachment bolt or the like the main shaft member to either of two members being linked in a vibration-damping manner, and securing the outer cylinder member press-fit into a mounting hole provided in the other part being linked in a vibration-damping manner. In such cases, the vibration damping bushing is typically traverse-mounted with its axial direction oriented on the horizontal, with the axial direction of the vibration damping bushing aligned with the longitudinal direction of the vehicle, for example. When vibration is input to the vibration damping bushing, the vibration is effectively attenuated by means of elastic deformation of the rubber elastic body.

In the vibration damping bushings of the kind described above, the spring characteristics in the vertical and front-back or longitudinal direction of the vehicle mainly affect passenger ride comfort, while spring characteristics in the left-right or lateral direction of the vehicle mainly affect driver maneuvering stability. Thus, the spring characteristics in the axial direction and axis perpendicular direction are adjusted appropriately as needed by providing the rubber elastic body with a hollow extending in the axial direction or a through-hole penetrating through in the axial direction. The spring constant in the axial direction is low, mainly due to force acting in the shear direction, while the spring constant in the axis perpendicular direction is high due mainly to the action of compression and force in the tensile direction. Thus, the spring ratio of the spring constant in the axial direction to that in the axis-perpendicular direction is typically on the order to 1:4.5-11, with spring in the axis-perpendicular direction being several times greater than spring in the axial direction.

Vibration damping bushings of the kind described above are typically employed in traverse-mounted arrangements, but in some instances it is necessary due to vehicle layout or to the need to conserve space, to arrange a vibration damping bushing in a vertical-mounted arrangement, whereby the axial direction of the vibration damping bushing is aligned with the vertical direction. In such instances, it becomes necessary to increase spring in the axial direction to a level equal to or greater than spring in the axis-perpendicular direction, in order to achieve a good balance of both passenger comfort and driver maneuvering stability.

### SUMMARY OF THE INVENTION

It is therefore one object of this invention to provide a vibration damping bushing for vertical-mounted installation, which vibration damping bushing affords a good balance of both passenger comfort and driver maneuvering stability.

The above and/or other objects may be attained according to at least one of the following features of the invention. The following preferred forms of the invention may be adopted at any possible optional combinations. It is to be understood that the present invention is not limited to the following features or combinations of these features, but may otherwise be recognized based on the thought of the present invention that described in the whole specification and drawings or that may be recognized by those skilled in the art in the light of the disclosure in the whole specification and drawings.

The principle of the present invention provides a vibration damping bushing comprising: a main shaft member having a cylindrical portion and a protuberant portion formed at one end of the cylindrical portion so as to project outwardly in one diametric direction perpendicular to an axial direction of the main shaft member, the protuberant portion having a sloping face that thrusts diametrically outward from an outer circumferential surface of the cylindrical portion while extending axially outwardly; an outer cylinder member disposed coaxially about the main shaft member with a given distance therebetween; and a rubber elastic body bonded to an outer circumferential surface of the main shaft member including the sloping face and to an inner circumferential surface of the outer cylinder member, so as to connect elastically the main shaft member and the outer cylinder member, wherein the rubber elastic body has a pair of outer hollow portions disposed to an outer circumferential portion thereof at respective circumferential locations opposed to each other in the one diametric direction in which the protuberant portion projects outwardly, and a pair of inner hollow portions disposed to an inner circumferential portion thereof at respective circumferential locations opposed to each other in the one diametric direction, so that there is disposed between the inner hollow portions and the outer hollow portions a pair of sloping arm portions formed so as to slope diametrically inward going from the inner circumferential surface of the outer cylinder member to the sloping face of the main shaft member.

In the vibration damping bushing of the present invention, the rubber elastic body is provided with sloping arm portions formed between inner hollow portions and outer hollow portions, whereby the compression component is increased in the axial direction, to give higher spring in the axial direction. Additionally, the provision of outer hollow portions and inner hollow portions reduces the compression component in the axis-perpendicular direction, reducing spring in the axis-perpendicular direction. This arrangement makes it possible to establish the axial direction to axis perpendicular direction spring ratio at a level of 1:1 or lower. Therefore, it becomes possible to achieve a good balance of both passenger comfort and driver maneuvering stability, when the vibration damping bushing is installed on a vehicle in a vertical mounting arrangement.

Preferably, the protuberant portion of the main shaft member has an annular configuration with an outside diameter gradually increases in an axially outward direction so as to provide the sloping face in all diametric directions perpendicular to the axial direction of the main shaft member. This arrangement permits an easy assembly of the main shaft member against the outer cylinder member with no problem of direction. To further ensure the effect of the present invention, an amount of protuberant (B) of the protuberant portion in the axial direction from the outer circumferential surface of the cylindrical portion of the main shaft member is not smaller than one-third of the diametric distance (A) between the inner circumferential surface of the outer cylinder member and the inner circumferential surface of the cylindrical portion. With this arrangement, a volume of the sloping arm portions can be effectively obtained, whereby the compression component is increased in the axial direction, to give higher spring in the axial direction.

In the present invention, preferably, the inner hollow portions and outer hollow portions are formed so as to overlap partially in the circumferential direction. With this arrangement, the axis-perpendicular direction compression component can be eliminated in the sloping arm portions, and spring in the axis-perpendicular direction can be made lower, so that spring in the axial direction is relatively greater.

Preferably, the inner hollow portions are formed so as to extend into proximity with the sloping face. With this arrangement, the angle of slope of the sloping arm portions with respect to the axis of the main shaft member can be made smaller, so that spring in the axial direction of the sloping arm portions can be increased. Further, in preferred practice, the inner hollow portions are formed so as to have greater depth in the axial direction than do the outer hollow portions. With this arrangement, the angle of slope of the sloping arm portions with respect to the axis of the main shaft member can be made smaller, so that spring in the axial direction of the sloping arm portions can be increased.

Also in a further preferred practice, the angle of slope of the sloping face of the protuberant portion is held in a range of 40-50° with respect to an axis of the main shaft member. With this arrangement, compressive force can be made to act efficiently in the axial direction of the sloping arm portions from the sloping face of the main shaft member, whereby spring in the axial direction of the sloping arm portions can be increased advantageously.

In the present invention, in the case where it is necessary to adjust axis-perpendicular direction spring in a 90° phase-shifted direction, a pair of axially perforating through-holes are provided at axis-symmetric locations in the rubber elastic body, to either side of the main shaft member. With this arrangement, when the vibration damping bushing is installed in a vertical mounting arrangement on a vehicle, spring in the vehicle lateral direction and longitudinal direction can each be adjusted as needed. For instance, the vibration damping bushing of the present invention will exhibit a spring ratio of a spring constant in the vehicle vertical direction to a spring constant in the vehicle longitudinal direction at a level of 1:1 or lower.

According to the vibration damping bushing of the invention, the rubber elastic body has outer hollow portions extending in the axial direction from the outside peripheral portion of the end face on the protuberant portion side, and inner hollow portions extending in the axial direction from the inner circumferential portion of the end face on the side opposite from the protuberant portion, with there being disposed between the inner hollow portions and the outer hollow portions sloping arm portions formed so as to slope diametrically inward going from the inside circumferential surface of the outer cylinder member to the sloping face of the main shaft member, whereby spring in the axial direction can be increased appreciably, making it possible to achieve a good balance of both passenger comfort and driver maneuvering stability, when installed on a vehicle in a vertical mounting arrangement.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is an axial cross sectional view of a vibration damping bushing of construction according to one embodiment of the invention, taken along line 1-1 of FIG. 2; and

FIG. 2 is a top plane view of the vibration damping bushing of FIG. 1.

### DETAILED DESCRIPTION OF PREFERRED EMBODIMENTS

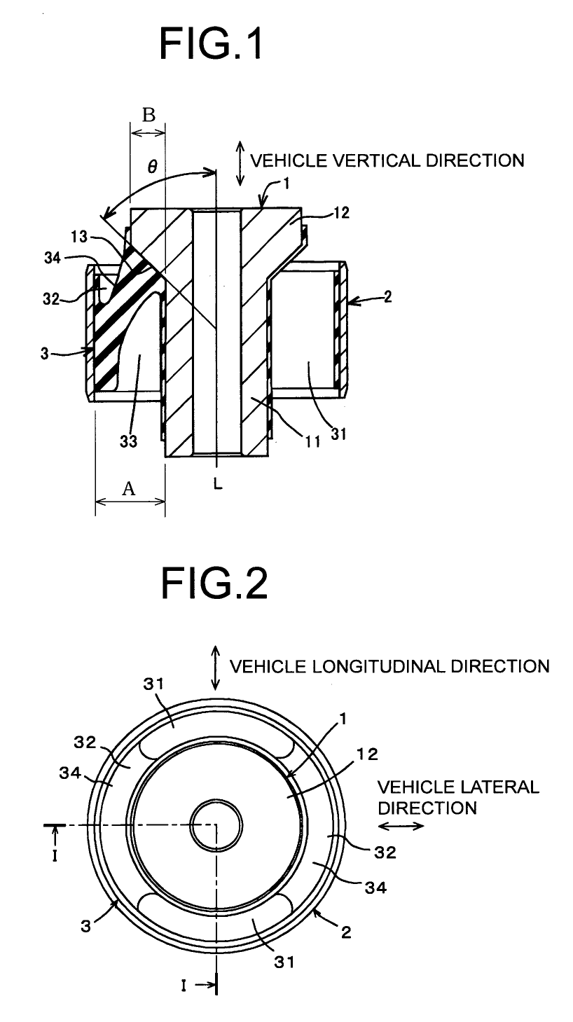

As shown in FIG. 1 and FIG. 2, the vibration damping bushing of the embodiment is composed of a main shaft member 1 having a cylindrical portion 11 and a protuberant portion 12 with a sloping face 13; an outer cylinder member 2 disposed coaxially with the main shaft member 1 and spaced apart to the outer peripheral side thereof; and a rubber elastic body 3 interposed between the main shaft member 1 and the outer cylinder member 2 integrally linking the two members 1, 2, and having sloping arm portions 34, 34 formed between outer hollow portions 32, 32 and inner hollow portions 33, 33.

The main shaft member 1 is of thick-walled cylindrical shape fabricated of ferrous metal, comprising a cylindrical portion 11 and a protuberant portion 12 that thrusts diametrically outward from one end (the upper end in FIG. 1) of the cylindrical portion 11. On the axially inward side of the protuberant portion 12 is formed a sloping face 13 that increases in diameter going towards one end (the upper end in FIG. 1) of the main shaft member 1. This sloping face 13 is formed so as to produce a 45° angle of slope θ with respect to the axis L of the main shaft member 1. An amount of protuberant (B) of the protuberant portion 12 in the axial direction from the outer circumferential surface of the cylindrical portion 11 of the main shaft member 1 is not smaller than one-third of the diametric distance (A) between the inner circumferential surface of the outer cylinder member 2 and the inner circumferential surface of the cylindrical portion 11.

The outer cylinder member 2 is of thin-walled cylindrical shape fabricated of ferrous metal. This outer cylinder member 2 has an inside dimension larger by a predetermined dimension than the outside diameter of the protuberant portion 12 of the main shaft member 1, and length approximately one-half that of the main shaft member 1. This outer cylinder member 2 is arranged coaxially with the main shaft member 1 spaced apart to the outside peripheral side of the axial center portion thereof.

The rubber elastic body 3 is of generally cylindrical shape interposed between the main shaft member 1 and the outer cylinder member 2, by means of integral vulcanization molding of rubber material together with the main shaft member 1 and outer cylinder member 2. This rubber elastic body 3 is vulcanization bonded to a portion of the outer circumferential surface of the main shaft member 1 (including the sloping face 13) excluding the two end portions thereof, and to a portion of the inner circumferential surface of the outer cylinder member 2 excluding the two end portions thereof, thereby integrally connecting the main shaft member 1 with the outer cylinder member 2. In axis-symmetrical areas of the rubber elastic body 3 to either side of the main shaft member 1 are disposed a pair of through-holes 31, 31 perforating it in the axial direction, whose cross section is an arcuate shape extending the circumferential direction. These through-holes 31, 31 each extend in the circumferential direction over a range approximately one-fourth of the distance around the circumference.

At locations of the rubber elastic body 3, phase-shifted 90° from the pair of through-holes 31, 31 centered on the axis L in a plane orthogonal to the axis L (locations devoid of the pair of through-holes 31, 31 in the circumferential direction), there are disposed a pair of outer hollow portions 32, 32 at respective circumferential positions opposed to each other in the diametric direction so as to extend in the axial direction from the outside peripheral portion of the end face on the protuberant portion 12 side, and arcuate inner hollow portions 33, 33 at respective circumferential positions opposed to each other in the diametric direction so as to extend in the axial direction from the inner circumferential portion of the end face on the side opposite the protuberant portion 12. The outer hollow portions 32, 32 are formed with arcuate shape, extending in the circumferential direction along the outer circumferential surface of the rubber elastic body 3 at locations offset slightly inward from the outer circumferential surface. The outer hollow portions 32, 32 are formed with depth approximately one-fourth the axial length of the outer peripheral portion of the rubber elastic body 3.

The inner hollow portions 33, 33, meanwhile, are formed with arcuate shape extending in the circumferential direction along the inner circumferential surface of the rubber elastic body 3 at locations offset slightly outward from the inner circumferential surface. These inner hollow portions 33, 33 extend into proximity with the sloping face 13 of the main shaft member 1, with their bottom portions overlapping the bottom portions of the outer hollow portions 32, 32 in the diametrical direction. The inner hollow portions 33, 33 are formed with greater depth in the axial direction than the outer hollow portions 32, 32.

By means of forming these outer hollow portions 32, 32 and inner hollow portions 33, 33, sloping arm portions 34, 34 are formed between the outer hollow portions 32, 32 and inner hollow portions 33, 33. These sloping arm portions 34, 34 are formed so as to slope diametrically inward going from the inner circumferential surface of the outer cylinder member 2 towards the sloping face 13 of the main shaft member 1.

By disposing the sloping arm portions 34, 34 in this way, the compression component with respect to the axial direction is increased, producing higher spring in the axial direction. Additionally, the provision of the outer hollow portions 32, 32 and inner hollow portions 33, 33 reduces the compression component with respect to the axis-perpendicular direction, reducing spring in the axis-perpendicular direction. Incidentally, with this embodiment, there is achieved a spring ratio of 1:1:0.5 for the axial direction (vertical direction of the vehicle), the direction of opposition of the sloping arm portions 34, 34 (lateral direction of the vehicle), and the direction of opposition of the through-holes 31, 31 (longitudinal direction of the vehicle).

The vibration damping bushing of the embodiment having the arrangement described hereinabove is mounted by securing the main shaft member 1 with an attachment bolt (not shown) or the like to either of the parts being linked in a vibration-damped manner, and securing the outer cylinder member 2 press-fit into a mounting hole provided in the other part being linked in a vibration-damped manner. In this case, vertical-mounting installation is performed such that, with respect to the vehicle body, the protuberant portion 12 of the main shaft member 1 is positioned above and the axis L is oriented in the vertical direction, and attachment is performed such that the pair of sloping arm portions 34, 34 are positioned in the lateral direction of the vehicle, and the pair of through-holes 31, 31 are positioned in the longitudinal direction of the vehicle. By so doing, the vibration damping bushing is mounted in such a way that the spring ratio for the vehicle vertical direction, lateral direction, and longitudinal direction is 1:1:0.5.

In this way, in the vibration damping bushing of the embodiment, outer hollow portions 32, 32 and inner hollow portions 33, 33 are provided in the rubber elastic body 3, and sloping arm portions 34, 34 are formed between the two kinds of hollow portions 32, 33, thereby increasing the compression component with respect to the axial direction so that spring in the axial direction can be made higher, as well as decreasing the compression component in the axis-perpendicular direction so that spring in the axis-perpendicular direction can be lowered. By so doing, the axial direction to axis-perpendicular direction spring ratio can be established at 1:1 or lower, so that when the vibration damping bushing is installed in a vertical mounted configuration onto a vehicle, a good balance of both passenger comfort and driver maneuvering stability can be achieved.

Additionally, by forming the outer hollow portions 32, 32 and inner hollow portions 33, 33 so that their bottom portions overlap in the diametrical direction, the compression component in axis-perpendicular direction can be eliminated in the sloping arm portions 34, 34, and spring in the axis-perpendicular direction can be lowered so that spring in the axial direction is relatively higher.

Further, since the inner hollow portions 33, 33 are formed so as to extend into proximity with the sloping face 13 of the main shaft member 1, the angle of slope of the sloping arm portions 34, 34 with respect to the axis L of the main shaft member 1 can be made smaller, whereby spring in the axial direction of the sloping arm portions 34, 34 can be made higher. Further, by forming the inner hollow portions 33, 33 with greater depth than the outer hollow portions 32, 32, spring in the axial direction of the sloping arm portions 34, 34 can be made higher in the same way as mentioned previously.

Additionally, since the sloping face 13 of the main shaft member 1 has a 45° angle of slope θ with respect to the axis L of the main shaft member 1, compressing force in the axial direction from the sloping face 13 of the main shaft member 1 to the sloping arm portions 34, 34 acts efficiently, which is advantageous in terms of higher spring in the axial direction of the sloping arm portions 34, 34.

Further, a pair of axially perforating through-holes 31, 31 are provided at axis-symmetric locations of the rubber elastic body 3 to either side of the main shaft member 1, and spring in the axis-perpendicular direction spring is adjusted in a 90° phase-shifted direction, whereby spring in the vehicle lateral direction and longitudinal direction can each be adjusted as needed. In the embodiment herein, the spring ratio for the vehicle lateral direction and longitudinal direction is 1:0.5. The through-holes 31, 31 contribute significantly for the purpose of establishing the axial direction to axis-perpendicular direction spring ratio at 1:1 or lower.

While it is not clearly shown in the present embodiment, a rubber stop member may be disposed within the inner hollow portions so as to limit an excess displacement of the main shaft member 1 relative to the outer cylinder member 2 in the lateral direction of the vehicle, as needed. For instance, the rubber stop member may be integrally formed with the rubber elastic body and projected from one of the main shaft member 1 and the outer cylinder member 2 toward the other of the two members 1 and 2.

It is also to be understood that the present invention may be embodied with various other changes, modifications and improvements, which may occur to those skilled in the art, without departing from the spirit and scope of the invention defined in the following claims.

1. A vibration damping bushing comprising:
a main shaft member having a cylindrical portion and a protuberant portion formed at one end of the cylindrical portion so as to project outwardly in one diametric direction perpendicular to an axial direction of the main shaft member, the protuberant portion having a sloping face that thrusts diametrically outward from an outer circumferential surface of the cylindrical portion while extending axially outwardly;
an outer cylinder member disposed coaxially about the main shaft member with a given distance therebetween; and
a rubber elastic body bonded to an outer circumferential surface of the main shaft member including the sloping face and to an inner circumferential surface of the outer cylinder member, so as to connect elastically the main shaft member and the outer cylinder member,
wherein the rubber elastic body has a pair of outer hollow portions disposed to an outer circumferential portion thereof at respective circumferential locations opposed to each other in the one diametric direction in which the protuberant portion projects outwardly, and a pair of inner hollow portions disposed to an inner circumferential portion thereof at respective circumferential locations opposed to each other in the one diametric direction, so that there is disposed between the inner hollow portions and the outer hollow portions a pair of sloping arm portions formed so as to slope diametrically inward going from the inner circumferential surface of the outer cylinder member to the sloping face of the main shaft member.

2. A vibration damping bushing according to claim 1, wherein the protuberant portion of the main shaft member has an annular configuration with an outside diameter gradually increases in an axially outward direction so as to provide the sloping face in all diametric directions perpendicular to the axial direction of the main shaft member.

3. A vibration damping bushing according to claim 1, wherein the inner hollow portions and outer hollow portions are formed so as to overlap partially in the one diametric direction.

4. A vibration damping bushing according to claim 1, wherein the inner hollow portions are formed so as to extend into proximity with the sloping face.

5. A vibration damping bushing according to claim 1, wherein the inner hollow portions are formed so as to have greater depth in the axial direction than do the outer hollow portions.

6. A vibration damping bushing according to claim 1, wherein an angle of slope of the sloping face of the protuberant portion is held in a range of 40-50° with respect to an axis of the main shaft member.

7. A vibration damping bushing according to claim 1, wherein a pair of axially perforation through-holes are provided at axis-symmetric locations in the rubber elastic body, to either side of the main shaft member.

8. A vibration damping bushing according to claim 1, wherein the bushing is installed in a vertical mounting arrangement on a vehicle with an axis thereof being oriented in a vertical direction, and exhibits a spring ratio of a spring constant in a vehicle vertical direction to a spring constant in a vehicle lateral direction at a level of 1:1 or lower.

9. A vibration damping bushing according to claim 1, wherein an amount of protuberant (B) of the protuberant portion in the axial direction from the outer circumferential surface of the cylindrical portion of the main shaft member is not smaller than one-third of the diametric distance (A) between the inner circumferential surface of the outer cylinder member and the inner circumferential surface of the cylindrical portion.
